(19) United States
(12) Patent Application Publication
(10) Pub. No.: US 2026/0083603 A1
(43) Pub. Date: Mar. 26, 2026

(54) AUXILIARY MOBILITY ATTACHMENTS FOR WHEELCHAIRS

(71) Applicant: BATEC MOBILITY, S.L., SANT QUIRZE DEL VALLÈS (ES)

(72) Inventor: PABLO ALEJANDRO BACH CASTILLO, SANT CUGAT DEL VALLES (ES)

(21) Appl. No.: 19/337,297

(22) Filed: Sep. 23, 2025

(30) Foreign Application Priority Data
Sep. 23, 2024 (EP) 24383022.1

(51) Int. Cl. A61G 5/04; A61G 5/10

(52) U.S. Cl. CPC A61G 5/047; A61G 5/1051

(57) ABSTRACT

An auxiliary mobility attachment for a wheelchair having an auxiliary frame to support a driving wheel and a handlebar. The auxiliary frame includes an auxiliary connector configured to be releasably attached to a wheelchair connector. The auxiliary connector includes a connector body having an approach slot to receive an approach rod of the wheelchair connector and an anchoring bar configured to fasten the approach rod.

### CROSS-REFERENCE TO RELATED APPLICATIONS

This application claims the benefit of European Patent Application EP24383022.1, filed on Sep. 23, 2024, which is incorporated herein by reference in its entirety.

The present disclosure relates to auxiliary mobility attachments for wheelchairs, and mobility assemblies for wheelchairs.

### BACKGROUND

The auxiliary mobility attachments enable the conversion of a wheelchair into a chair in the form of a tricycle or similar. The auxiliary mobility attachments may include manual or electric driving mechanisms that significantly enhance the mobility of the user.

The auxiliary mobility attachments usually include coupling elements that may allow a detachable connection with the wheelchair. In some cases, obtaining an appropriate coupling between the auxiliary mobility attachment and the wheelchair may depend on the force, skills, or capabilities of the user. The proper coupling may also depend on the conditions of the ground, for instance, even or rugged, flat or sloped, etc. The rugged and sloped ground can additionally hamper the coupling. Therefore, there are several features that may interfere with the above coupling.

The present disclosure provides examples of auxiliary mobility attachments and mobility assemblies that at least partially resolve some of the aforementioned disadvantages.

### SUMMARY

In a first aspect, an auxiliary mobility attachment is disclosed. The auxiliary mobility attachment comprises an auxiliary frame to support a driving wheel and a handlebar. The auxiliary frame comprises an auxiliary connector configured to be releasably attached to a wheelchair connector. The auxiliary connector comprises a connector body. The connector body comprises an approach slot configured to receive at least a portion of an approach rod of the wheelchair connector. The connector body further comprises an anchoring bar configured to fasten the approach rod. The anchoring bar is configured to be moved relative to the connector body at least between an extended position and a retracted position. The approach slot is configured to receive the approach rod in the retracted position.

According to this aspect, an auxiliary mobility attachment able to be easily coupled with the wheelchair is provided. Operation of the anchoring bar may allow the approach of the approach rod to the approach slot. This may result in a more comfortable and pleasant operation for the user.

An appropriate coupling between the auxiliary mobility attachment and the wheelchair may be obtained regardless of the force, skills, or capabilities of the user. The system according to the first aspect may help users with reduced mobility in the arms such as elder users or tetraplegic users to correctly place the approach rod in the approach slot. The risk of these users falling during the coupling maneuver between the auxiliary mobility attachment and the wheelchair is avoided or at least reduced.

Furthermore, the appropriate coupling may be achieved regardless of the conditions of the ground, such as even or uneven, flat or sloped. A sloped or inclined surface may cause that the user to exert more force to put the approach rod in the approach slot.

Moreover, the coupling between the auxiliary mobility attachment and the wheelchair connector may be reliably achieved. A correct coupling may avoid the risk of the auxiliary mobility attachment being decoupled from the wheelchair in an undesirable way.

The decoupling operation between the auxiliary mobility attachment and the wheelchair connector may be performed in a smooth way by implementing the auxiliary mobility attachment of the first aspect.

In a further aspect, a mobility assembly for a wheelchair is disclosed. The mobility assembly comprises an auxiliary mobility attachment according to any of the examples disclosed herein, and a wheelchair connector configured to be fastened to the wheelchair.

Advantages derived from this aspect may be similar to those mentioned regarding the first aspect.

In yet a further aspect, a method for coupling an auxiliary mobility attachment with a wheelchair connector, is disclosed. The method comprises fastening an approach rod of the wheelchair connector with an anchoring bar of the auxiliary mobility attachment; and moving the approach rod to an approach slot in such a way that the cross section of the approach rod is received withing the cross section of the approach slot.

Advantages derived from this aspect may be similar to those mentioned regarding the first aspect.

Throughout the present disclosure, expressions such as above, below, side, forward, backward, horizontal, longitudinal, etc are to be understood taking into account the construction of an auxiliary mobility attachment in an operating condition as a reference.

### DESCRIPTION OF THE DRAWINGS

Non-limiting examples of the present disclosure will be described in the following, with reference to the appended drawings, in which:

FIG. 1 schematically illustrates an auxiliary mobility attachment according to one example of the present disclosure;

FIG. 2 schematically illustrates a perspective view of a wheelchair connector to be releasably attached to the auxiliary mobility attachment of FIG. 1 according to one example of the present disclosure;

FIGS. 3 to 5 schematically illustrate an auxiliary mobility attachment and a wheelchair in three different positions relative to each other according to examples of the present disclosure;

FIG. 6 schematically illustrates an auxiliary connector and a wheelchair connector according to one example of the present disclosure;

FIGS. 7A-7B schematically illustrate a side view and a front view of an anchoring bar of the auxiliary connector of FIG. 6 according to one example of the present disclosure;

FIGS. 8 to 12 schematically illustrate the auxiliary connector and the wheelchair connector of FIG. 6 in different positions according to one example of the present disclosure;

FIG. 13 schematically illustrates an auxiliary connector and a wheelchair connector according to one example of the present disclosure;

FIGS. 14A-14B schematically illustrate a side view and a front view of an anchoring bar of the auxiliary connector of FIG. 13 according to one example of the present disclosure;

FIGS. 15 to 19 schematically illustrate the auxiliary connector and the wheelchair connector of FIG. 13 in different positions according to one example of the present disclosure; and

FIG. 20 is a block diagram of a method for coupling an auxiliary mobility attachment with a wheelchair connector according to an example of the present disclosure.

### DETAILED DESCRIPTION OF EXAMPLES

In these figures, the same reference signs have been used to designate matching elements.

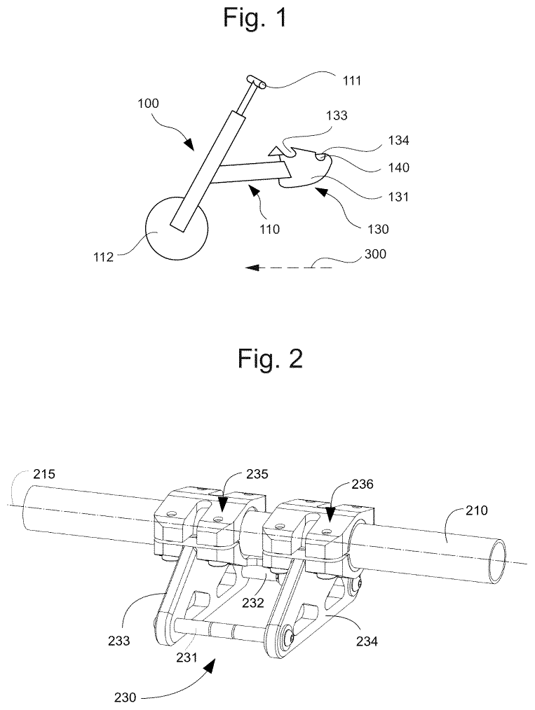

FIG. 1 schematically illustrates an auxiliary mobility attachment 100 according to one example of the present disclosure. The auxiliary mobility attachment 100 is suitable for a wheelchair. This way, the wheelchair may be converted into a chair in the form of a tricycle or similar.

The auxiliary mobility attachment 100 comprises an auxiliary frame 110 configured to support a driving wheel 112 and a handlebar 111. The handlebar 111 can turn the driving wheel 112. The auxiliary mobility attachment 100 may be hand-driven or driven by an electric motor. Also illustrated in FIG. 1 is a forward direction 300 of the auxiliary mobility attachment 100. This forward direction 300 can be referenced in both directions of travel, i.e. forward and reverse. This forward direction 300 is also related to the wheelchair when coupled with the auxiliary mobility attachment 100.

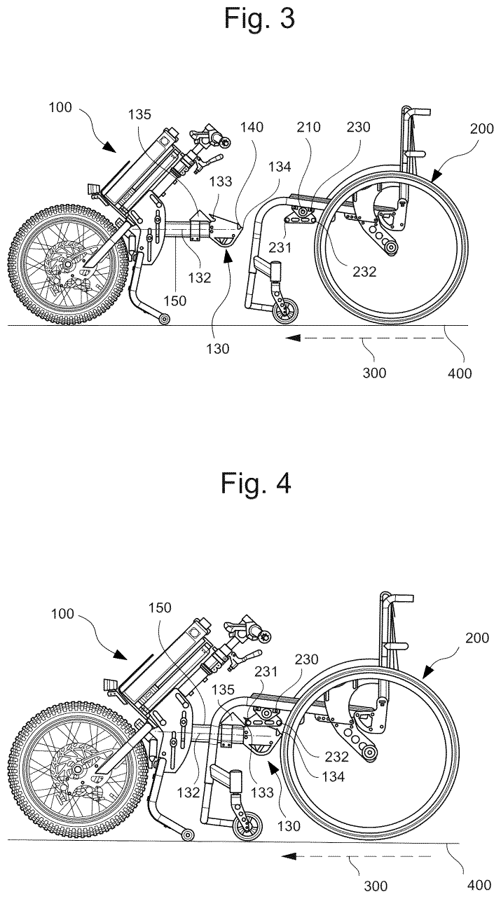

The auxiliary frame 110 comprises an auxiliary connector 130 configured to be releasably attached to a wheelchair connector 230. An example of a wheelchair connector 230 can be seen in FIG. 2.

The auxiliary connector 130 comprises a connector body 131. The connector body 131 of the Figures comprises a position slot 133 and an approach slot 134 that are configured to respectively receive a position rod 231 and an approach rod 232 of the wheelchair connector 230. The cross section of the position slot 133 may be configured to receive the cross section of the position rod. The cross section of the approach slot 134 may be configured to receive the cross section of the approach rod 232.

The position slot 133 and the position rod 231 form an example of positioner or position arrangement. The position arrangement may include mechanisms to substantially secure or fix the relative position of the auxiliary connector 130 and the wheelchair connector 230. In some non-illustrated examples, the auxiliary connector 130 may be void of positioner or position arrangement.

The auxiliary connector 130 also comprises an anchoring bar 140, 640 configured to fasten the approach rod 232. The anchoring bar 140, 640 is configured to be moved relative to the connector body 131 at least between an extended position and a retracted position. The approach slot 134 may be configured to receive the approach rod. The approach rod 232 is received in the approach slot 134 in the retracted position. Details about the extended position and the retracted position are disclosed herein.

The anchoring bar 140, 640 can be moved relative to the connector body 131 to secure the approach rod 232 and moving the approach rod 232 relative to the 134 so that the cross section of the approach rod 232 is substantially received within the cross section of the approach slot 134.

In case the auxiliary mobility attachment 100 comprises a position slot and position rod, the position slot 133 may be arranged between the driving wheel and the approach slot 134 along the longitudinal direction of the auxiliary mobility attachment 100. The longitudinal direction of the auxiliary mobility attachment may be substantially parallel to the forward direction 300 or direction of the movement of the wheelchair 200.

The wheelchair connector 230 can be configured to be releasably fastened to the wheelchair, for instance a crossbar 210 of the wheelchair. However, the wheelchair connector 230 may be integrally made with the rest of the wheelchair. The wheelchair connector 230 of FIG. 2 comprises a pair of crossbar plates 233, 234 mutually opposed and substantially parallel to each other. The crossbar plates 233, 234 are linked to the crossbar 210 through clamps 235, 236. The crossbar 210 of the wheelchair may be arranged such that the longitudinal axis 215 of the crossbar is substantially horizontal and transverse with respect to the forward direction 300. Crossbar plates 233, 234 can be arranged substantially perpendicular to the longitudinal axis 215 of the crossbar. Position rod 231 or a portion of the position rod 231 and approach rod 232 are arranged substantially parallel to the longitudinal axis 215 of the crossbar 210. The wheelchair connector 230 of FIG. 2 is a non-limiting example of wheelchair connector 230 for connecting the auxiliary mobility attachment 100 and the wheelchair in a releasable manner.

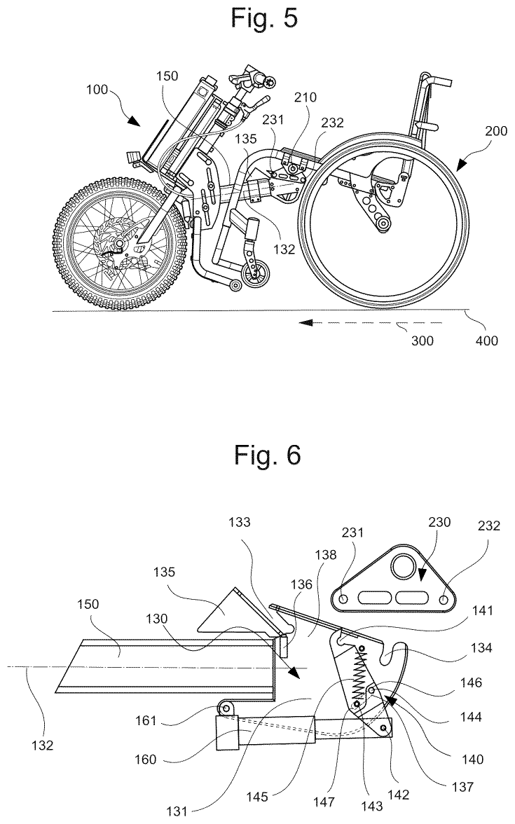

FIGS. 3 to 5 schematically illustrates the auxiliary mobility attachment 100 and the wheelchair 200 in three different positions relative to each other according to examples of the present disclosure.

In the example shown in FIG. 3, an uncoupled position of the auxiliary mobility attachment 100 and the wheelchair 200 is illustrated. The auxiliary mobility attachment 100 is positioned in front of the wheelchair 200 with respect to the forward direction 300.

The auxiliary mobility attachment 100 and wheelchair 200 can be brought together by the user as illustrated in FIG. 4. In FIG. 4 position rod 231 is received at position slot 133. As can be seen position slot 133 is arranged such that the length of position slot 133 is substantially horizontal and perpendicular to the longitudinal axis 132 of the anchoring arm 150. The approach slot 134 is also arranged such that the length of approach slot 134 is substantially horizontal and perpendicular to the longitudinal axis 132 of the anchoring arm 150. Longitudinal axis 132 of the anchoring arm 150 in FIG. 4 is arranged substantially parallel to the plane of the ground 400.

As can be seen in FIG. 4, position rod 231 is substantially received at position slot 133. The auxiliary mobility attachment 100 in FIG. 4 has a guiding protrusion 135. This guiding protrusion 135 may assist the user in inserting the position rod 231 into the position slot 133. As can be seen in FIG. 4, position slot 133 and approach slot 134 are arranged such that position slot 133 is positioned substantially higher than approach slot 134 in the uncoupled position. For this reason, an angle can be defined between a line joining the longitudinal axes of position slot 133 and approach slot 134 when seen from the side, and the longitudinal axis 132 of the anchoring arm 150.

In the example of FIG. 5, a coupled position of the auxiliary mobility attachment 100 and the wheelchair 200 is illustrated. In this coupled position, position rod 231 and approach rod 232 are substantially received at position slot 133 and approach slot 134 respectively. In this example of FIG. 5, longitudinal axis 132 of the anchoring arm 150 is disposed slightly inclined with respect to the plane of the ground 400. The anchoring bar 140 can hold the approach rod 232 in the retracted position while the auxiliary mobility attachment 100 and the wheelchair 200 are in a coupled position for instance in use.

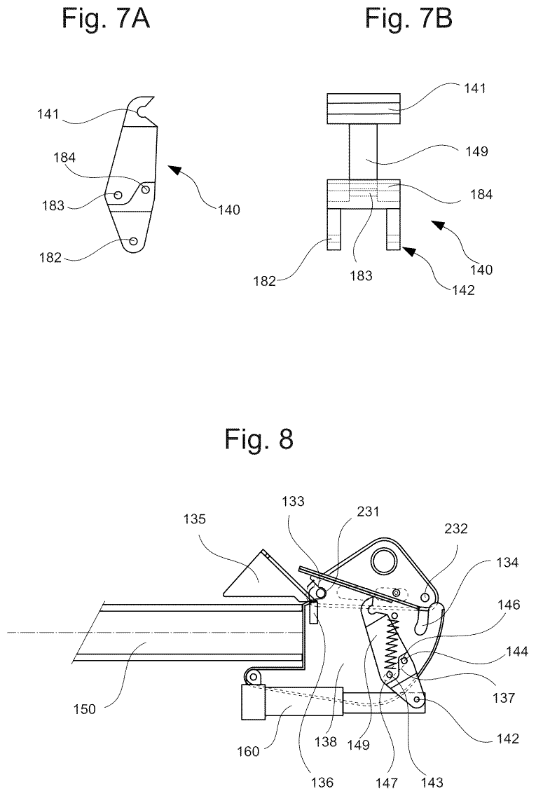

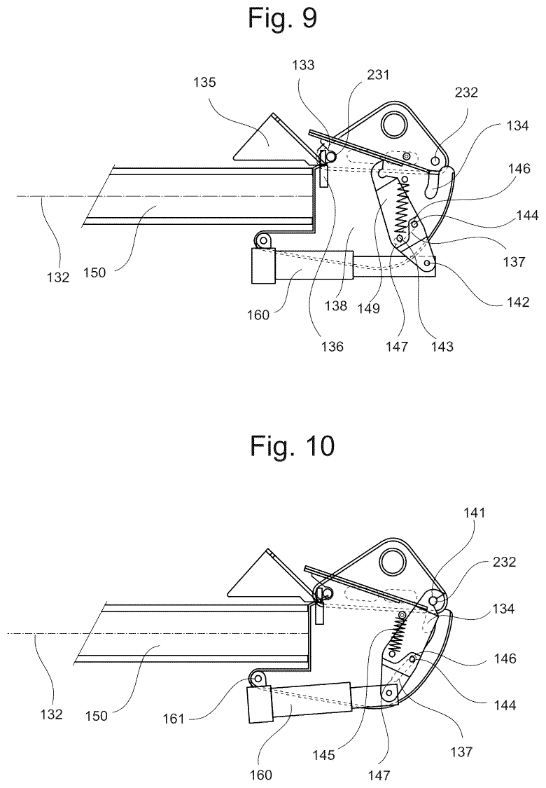

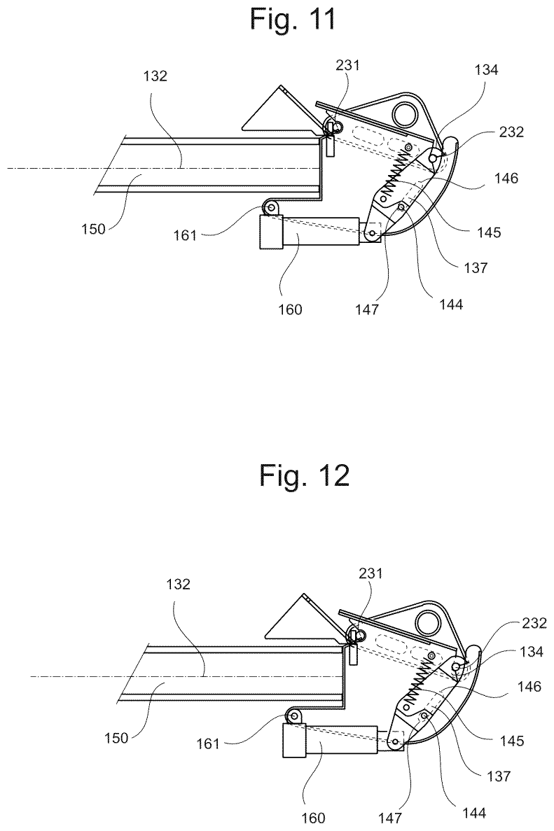

FIG. 6 schematically illustrates an auxiliary connector 130 and a wheelchair connector 230 according to one example of the present disclosure. FIGS. 7A-7B schematically illustrate a side view and a front view of the anchoring bar 140 of the auxiliary connector 130 of the FIG. 6 according to one example of the present disclosure. FIGS. 8 to 12 schematically illustrate the auxiliary connector and the wheelchair connector 230 of FIG. 6 in different positions according to one example of the present disclosure.

The connector body 131 may comprise a first side and a second side mutually opposed to each other. The anchoring bar 140 may be arranged between the first side and the second side. The first side and the second side may comprise respectively auxiliary plates 138 arranged parallel to each other on both sides of the longitudinal axis 132 of the anchoring arm. The connector body 131 is arranged at one end of the anchoring arm 150 configured to join the wheelchair 200. The auxiliary plates 138 may be joined together to form a housing-like structure housing components of the auxiliary connector 130. In FIGS. 6, 8-12, the connector body 131 has been shown with a single auxiliary plate 138 for the sake of clarity.

As can be seen in the examples of FIGS. 6, 8-12, the auxiliary connector 130 comprises an actuator 160 configured to move the anchoring bar 140 relative to the connector body 131 between the extended position and the retracted position. The extended position can be seen in FIG. 10 while the retracted position can be seen in FIG. 11. The actuator 160 may also be configured to move the anchoring bar 140 from a first position as illustrated in FIGS. 6, 8, or 9 to the extended position of FIG. 10. The actuator may be a linear actuator or linear drive. The actuator may be fed by a power source like a battery. In some examples, the battery can also feed the electric motor for operating the driving wheel. The actuator 160 may be arranged substantially along the length of the anchoring arm 150. The actuator 160 of the attached Figures is powered by electric current from batteries. However, the actuator 160 may comprise hydraulic or pneumatic devices.

In some examples the actuator 160 may comprise an electric motor that rotates or moves the anchoring bar 140 directly in order to engage and move the approach rod 232. In these examples the electric motor may act on a first pin 144.

The first position is the position in which the anchoring bar 140, 640 is at rest. In this way, the anchoring bar 140, 640 may be protected from shocks. In some examples not illustrated, the anchoring bar 140, 640 may only be arranged between the extended position and the retracted position.

In some examples, the anchoring bar 140, 640 may comprise a rocker rotatably attached to the connector body 131 through the first pin 144. The anchoring bar or rocker may comprise an anchoring end 141 to grip or hook the approach rod 232 and an operating end 142 to be connected to the actuator 160. As can be seen in FIG. 6, the first pin 144 is arranged between the anchoring end 141 and the operating end 142 relative to the length of the rocker. In the example of FIG. 7, the operating end comprises two legs that define a cavity to receive and connect the actuator 160 between both legs. In this example, the operating end 142 comprises a U-shaped configuration. Each leg comprises an operating through hole 182 to receive a second pin connecting the actuator 160 and the anchoring bar 140. The anchoring bar 140 comprises a first pin through hole 184 to pass the first pin 144.

According to some examples, the anchoring end 141 may comprise a V-shaped profile to correctly received the cross-section of approach rod 232.

The actuator 160 can be rotatably attached to the connector body 131 through the third pin 161. The third pin 161 may be arranged at the end of the actuator 160 opposite to the end to be connected with the operating end 142.

In the illustrated examples, the operating end 142, 642 is arranged below the anchoring end 141, 641. The force exerted by the actuator 160 when the actuator is extended or retracted may move the operating end 142, 642. A movement of the operating end 142 may cause the anchoring bar 140 to rotate about the first pin 144 clockwise or counterclockwise. Therefore, a first rotation axis can be defined through the first pin 144. The anchoring end may rotate about the first rotation axis. The actuator 160 is configured to rotatably move the rocker.

The connector body 131 may comprise a guide 137 or guiding element to slidably receive the first pin 144. The guide 137 may comprise an extended guide end 146 and a retracted guide end 147. The first pin 144 may be moved along the guide by the force exerted by the actuator 160. The actuator 160 may be configured to move the rocker such that the first pin 144 slidably moves between the extended guide end 146 and the retracted guide end 147.

In some examples, the guide 137 may be defined in such a way that when the first pin 144 substantially reaches the retracted guide end 147, the anchoring bar 140 may be arranged in the retracted position. Furthermore, when the first pin 144 substantially reaches the extended guide end 146, the anchoring bar 140 may be arranged in the extended position.

In the illustrated examples, the guide 137 comprises a slotted hole. The slotted hole can comprise any shaped path such as a curved path. The shape of the slotted hole may be chosen depending on the path followed by the anchoring end 141 from the expanded position to the retracted position. In examples, depending on the distance between the approach slot 134 and the approach rod 232 when seen from the side, the shape of the guide 137 may be varied accordingly.

The auxiliary connector 130 may comprise a spring 145 or any other elastic member between the connector body 131 and the anchoring bar 140 to urge the first pin 144 towards the extended guide end 146. The spring can be connected to the anchoring bar 140 through a third pin 143. The third pin 143 may be arranged at a third pin through hole 183 arranged in the anchoring bar 140. The spring 145 can be chosen to retain the first pin 144 at the extended guide end 146 depending on the position of the actuator 160. When the actuator 160 is further compressed, the spring is compressed and the first pin 144 is slidably moved from the extended guide end 146 towards the retracted guide end 147. The spring may be arranged substantially parallel to the auxiliary plates 138 and/or the elongated body of the anchoring bar 140. The anchoring bar 140 may comprise a recess to receive the spring 145.

In the illustrated examples, the auxiliary connector 130 comprises two springs 145 arranged at both sides of the anchoring bar 140. In this case, the anchoring bar 140 may comprise a pair of recesses at both sides of the length.

In some examples, the auxiliary connector 130 may comprise a lock 136 or latch to retain the position rod 231 in the position slot 133.

In some examples not shown, the anchoring bar 140 may comprise a linear actuator. In these examples the anchoring bar 140 may emerge towards the extended position to capture the approach rod 232 and compress towards the retracted position to accommodate the approach rod 232 within the approach slot 134. In these examples the anchoring bar 140 does not exhibit the first position as it emerges and retracts substantially in a linear fashion.

The example in FIG. 6 may be related to the example in FIG. 3. That is, in the example in FIG. 6 the auxiliary mobility attachment 100 and wheelchair 200 are in an uncoupled position with respect to each other. The example of FIG. 8 may be related to the example of FIG. 4. The examples of FIG. 11 or 12 may be related to the example of FIG. 5. i.e., in the example of FIG. 5 the auxiliary mobility attachment 100 and the wheelchair 200 are in a position coupled to each other.

In the following some details about the operation of the auxiliary mobility attachment 100 in relationship with the examples of FIG. 6-12 are provided.

The linear actuator 160 is in an extended position in FIG. 6. The extension of the linear actuator 160 is substantially defined along the forward direction 300. The first pin 144 is located at the extended guide end 146. Thus, the anchoring end 141 is received inside the connector body 131 at the first position. The lock 136 is substantially retracted to receive the position rod 231.

The user can bring together auxiliary mobility attachment 100 and wheelchair 200 and introduce the position rod 231 inside the position slot 133 as illustrated in FIG. 8. The linear actuator 160, the anchoring bar 140 and the lock 136 remain in the same position as in the FIG. 6. In some examples, the user may operate a command to actuate the lock 136 to reliably block the position rod 231 inside the position slot 133. However, auxiliary mobility attachment 100 may comprise a sensor configured to detect the presence of position rod 231 inside the 133 and operate the lock 136. A non-illustrated control unit may command the lock 136 when receiving presence data from the sensor.

In FIG. 10, the actuator 160 is operated. The actuator 160 can be actuated by the user or the control unit may command the actuator 160 to be retracted. As the actuator 160 is retracted, the anchoring bar 140 is rotated clockwise. Therefore, the anchoring end 141 can anchor the approach rod 232. The spring 145 has been compressed.

In FIG. 11, the actuator 160 is further operated to be further retracted. Thus, the actuator pulls the anchoring bar 140 by the operating end 142 towards the actuator 160. This causes that the first pin 144 to slide through guide 137 from the extended guide end 146 towards the retracted guide end 147. The spring 145 is substantially expanded as the third pin 143 is also moved by the action of the actuator 160. In FIG. 11, the approach rod 232 is substantially in a retracted position. In FIG. 12, the first pin 144 is about to reach the retracted guide end 147.

If a control unit commands the operation, the coupling and decoupling operations may be substantially automatically performed. It the user commands the operation, then the auxiliary mobility attachment assists in the coupling and decoupling operations.

When the user wants to decouple the auxiliary mobility attachment 100 from the wheelchair 200 simply follow the above process in a reverse order.

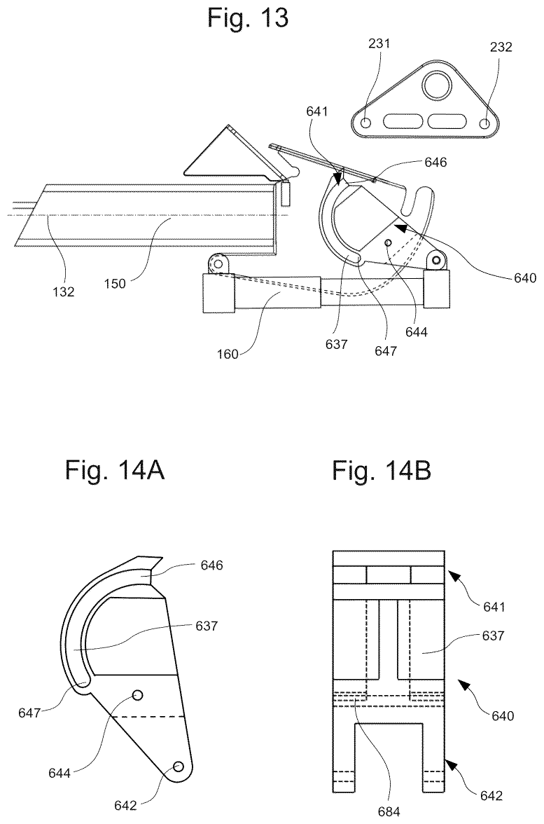

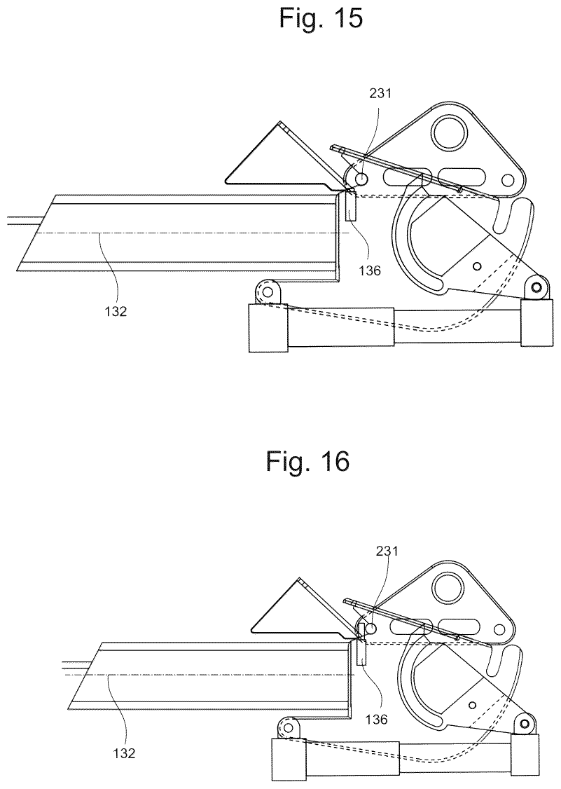

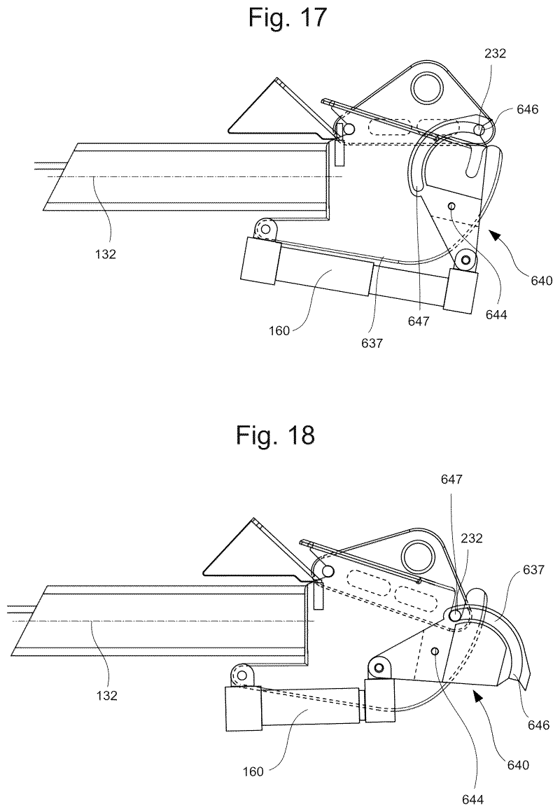

FIG. 13 schematically illustrates an auxiliary connector and a wheelchair connector according to one example of the present disclosure. FIGS. 14A-14B schematically illustrate a side view and a front view of an anchoring bar of the auxiliary connector of FIG. 13 according to one example of the present disclosure. FIGS. 15 to 19 schematically illustrate the auxiliary connector and the wheelchair connector of FIG. 13 in different positions according to one example of the present disclosure.

The example in FIG. 13 may be related to the example in FIG. 3. That is, in the example in FIG. 13 the auxiliary mobility attachment 100 and wheelchair 200 are in an uncoupled position with respect to each other. The example of FIG. 14 may be related to the example of FIG. 4. The examples of FIG. 18 or 19 may be related to the example of FIG. 5. i.e., in the example of FIG. 5 the auxiliary mobility attachment 100 and the wheelchair 200 are in a position coupled to each other.

The examples in FIGS. 13-19 are similar to the examples described in relation to FIGS. 6-12. Therefore, the general principles may be applied to both examples. However, there are a number of differences related mostly to the configuration of anchoring bar 640. Furthermore, in the examples of FIG. 13-19, the approach rod 232 comprises two approach rod portions. The approach rod portions are arranged substantially along the same longitudinal axis.

As can be seen in FIGS. 14A, 14B the anchoring bar 640 comprises a side channel 637 to receive and guide at least a portion of the approach rod 232. The side channel 637 comprises an extended channel end 646 and a retracted channel end 647. In the illustrated examples, the anchoring bar 640 comprises two side channels 637. The two side channels are respectively positioned at both sides with respect to the longitudinal direction of the auxiliary mobility attachment 100. In the attached examples, the side channel 637 comprises a curved path. The shape of the curved path can be chosen depending on the case.

The shape of the guide 137 and the side channel 237 may define an approach path between the approach rod 232 and the approach slot 134.

In examples, the anchoring bar 640 may comprise a rocker rotatably attached to the connector body 131 through the first pin 644. The anchoring bar 640 comprises a first pin through hole 684 to pass the first pin 644. The anchoring bar or rocker may comprise an anchoring end 641 to grip or hook the portion of approach rod 232 and an operating end 642 to be connected to the actuator 160. As can be seen in FIG. 13, the first pin 644 is arranged between the anchoring end 641 and the operating end 642 relative to the length of the rocker. In the example of FIG. 14, the operating end comprises two legs that define a cavity to receive and connect the actuator 160 between both legs. In this example, the operating end 642 comprises a U-shaped configuration. Each leg comprises an operating through hole 682 to receive a second pin connecting the actuator 160 and the anchoring bar 640.

According to some examples, the anchoring end 641 may comprise a V-shaped profile to correctly received the cross-section of approach rod 232

In the examples of FIG. 13-19, the approach rod 232 may be moved along the side channel 637 by the force exerted by the actuator 160. The actuator 160 may be configured to move the rocker such that the approach rod 232 or portion of the approach rod 232 slidably moves between the extended channel end 646 and the retracted channel end 647.

In some examples, the side channel 637 can be defined in such a way that when the approach rod 232 or portion of the approach rod 232 substantially reaches the expanded guide end 646, the anchoring bar 640 may be arranged in the expanded position. Furthermore, when the approach rod 232 or portion of the approach rod 232 substantially reaches the retracted channel end 647, the anchoring bar 640 may be arranged in the retracted position.

In some examples, the actuator 160 may be configured to move the rocker such that the portion of the approach slot 232 can be slidably moved between the extended channel end 646 and the retracted channel end 647. Unlike the examples of FIG. 6-12, the auxiliary connector 130 is voided of spring 145. The first pin 644 can substantially remain in place while the anchoring bar 640 is rotated by the actuator 160.

In FIG. 13, the anchoring bar 640 is represented in the first position. In FIG. 17, the anchoring bar 640 is represented in the extended position. In FIG. 18, the anchoring bar 640 is represented in the retracted position.

In FIGS. 13 and 19, the illustrated examples of anchoring bars 140, 640 are positioned substantially in retracted positions. In FIG. 13 the first pin 144 has not substantially reach the retracted guide end 147 and in FIG. 19 the portion of the approach slot 232 has not substantially reached the retracted channel end 647. Those cases may allow to reduce the relative inclination between the auxiliary mobility attachment 100 and the wheelchair 200 along the forward direction 300. This may be useful for the case where the auxiliary mobility attachment 100 and the wheelchair 200 moves in a flat or smooth ground.

The actuator 160 may be configured to vary the location of the different parts at which the retracted position is achieved. The actuator 160 may be configured so that the stroke of the actuator 160 may be chosen to define extended position and retracted position.

The linear actuator 160 is in an extended position in FIG. 13. The extension of the linear actuator 160 is substantially defined along the forward direction 300. The anchoring end 641 is received inside the connector body 131 at the first position. The lock 136 is substantially retracted to receive the position rod 231.

The user can bring together auxiliary mobility attachment 100 and wheelchair 200 and introduce the position rod 231 inside the position slot 133 as illustrated in FIG. 15. The linear actuator 160, the anchoring bar 640 and the lock 136 remain in the same position as in the FIG. 13.

In FIG. 17, the actuator 160 is operated. The actuator 160 can be actuated by the user or the control unit may command the actuator 160 to be retracted. As the actuator 160 is retracted, the anchoring bar 640 is rotated clockwise. Therefore, the anchoring end 641 can anchor the portion of the approach rod 232.

In FIG. 18, the actuator 160 is further operated to be further retracted. Thus, the actuator pulls the anchoring bar 640 by the operating end 642 towards the actuator 160. This causes that the portion of the approach rod 232 to slide through side channel 637 from the extended channel end 646 towards the retracted channel end 647. In FIG. 18, the approach rod 232 is substantially in a retracted position. In FIG. 19, the portion of the approach rod 232 is about to reach the retracted channel end 647.

When the user wants to decouple the auxiliary mobility attachment 100 from the wheelchair 200 simply follow the above process in a reverse order.

According to a further aspect, a mobility assembly for a wheelchair is disclosed. The mobility assembly comprises the auxiliary mobility attachment 100 according to any of the examples disclosed herein and a wheelchair connector configured to be fastened to the wheelchair.

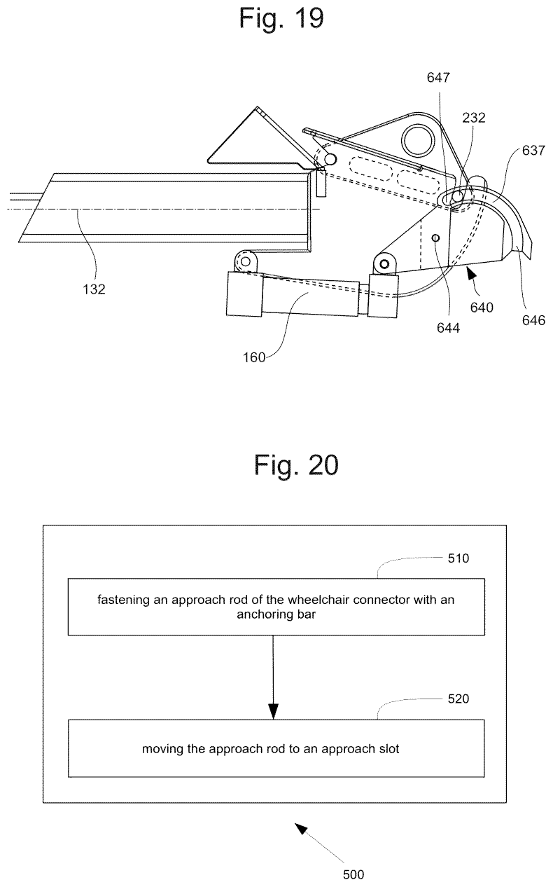

FIG. 20 is a block diagram of a method for coupling an auxiliary mobility attachment with a wheelchair connector according to an example of the present disclosure. A method 500 for coupling an auxiliary mobility attachment with a wheelchair connector according to the examples disclosed herein, may be implemented. The method 500 comprises fastening an approach rod 232 of the wheelchair connector with an anchoring bar 140, 640 of the auxiliary mobility attachment 100, as represented at block 510.

The anchoring bar 140, 640 may be actuated to adopt the extended position to capture the approach rod 232. The anchoring bar 140, 640 may be actuated according to any of the examples described in the present disclosure. The actuation may depend on commands from the control unit and/or commands from the user. In cases where the auxiliary connector 130 presents a position arrangement, the user may position and actuate the position arrangement prior to engaging the approach rod 232.

In block 520 moving the approach rod to an approach slot in such a way that the cross section of the approach rod 232 or a portion thereof is received withing the cross section of the approach slot, has been illustrated. The anchoring bar 140, 640 is moved to adopt the retracted position with the approach rod 232 engaged. This way, the auxiliary connector 130 and the wheelchair connector 230 which is attached to the wheelchair 200 may be brought closer together and engaged.

Although only a number of examples have been disclosed herein, other alternatives, modifications, uses, and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

For reasons of completeness, various aspects of the present disclosure are set out in the following numbered clauses:
Clause 1. An auxiliary mobility attachment for a wheelchair, comprising:
   an auxiliary frame to support a driving wheel and a handlebar;
   wherein the auxiliary frame comprises an auxiliary connector configured to be releasably attached to a wheelchair connector;
   wherein the auxiliary connector comprises:
      a connector body, wherein the connector body comprises an approach slot configured to receive at least a portion of an approach rod of the wheelchair connector;
      an anchoring bar configured to fasten the approach rod, wherein the anchoring bar is configured to be moved relative to the connector body at least between an extended position and a retracted position, wherein the approach slot is configured to receive the approach rod in the retracted position.
Clause 2. The auxiliary mobility attachment according to clause 1, wherein the auxiliary connector comprises an actuator to move the anchoring bar relative to the connector body between the extended position and the retracted position.
Clause 3. The auxiliary mobility attachment according to clause 2, wherein the anchoring bar comprises a rocker rotatably attached to the connector body through a first pin.
Clause 4. The auxiliary mobility attachment according to clause 3, wherein the actuator is configured to rotatably move the rocker.
Clause 5. The auxiliary mobility attachment according to any of clauses 2-3, wherein the connector body comprises a guide to slidably receive the first pin, wherein the guide comprises an extended guide end and a retracted guide end.
Clause 6. The auxiliary mobility attachment according to clause 5, wherein the guide comprises a slotted hole.
Clause 7. The auxiliary mobility attachment according to clause 6, wherein the slotted hole comprises a curved path.
Clause 8. The auxiliary mobility attachment according to any of clauses 5-7, wherein the auxiliary connector comprises a spring between the connector body and the anchoring bar to urge the first pin towards the retracted guide end.
Clause 9. The auxiliary mobility attachment according to clauses 3 and 5, wherein the actuator is configured to move the rocker such that the first pin is slidably moved between the extended guide end and the retracted guide end.
Clause 10. The auxiliary mobility attachment according to any of clauses 2-3, wherein anchoring bar comprises a side channel to receive and guide at least a portion of the approach slot, wherein the side channel comprises an extended channel end and a retracted channel end.
Clause 11. The auxiliary mobility attachment according to clause 10, wherein the side channel comprises a curved path.
Clause 12. The auxiliary mobility attachment according to clauses 3 and 10, wherein the actuator is configured to move the rocker such that the portion of the approach slot is slidably moved between the extended channel end and the retracted channel end.
Clause 13. The auxiliary mobility attachment according to any of clauses 10-12, wherein the anchoring bar comprises two side channels, wherein the two side channels are positioned at both sides with respect to the longitudinal direction of the auxiliary mobility attachment.
Clause 14. The auxiliary mobility attachment according to any of clauses 2-13, wherein the actuator comprises a linear actuator.
Clause 15. The auxiliary mobility attachment according to clause 3, wherein the rocker comprises an anchoring end to grip or attach the approach rod and an operating end to be connected to the actuator.
Clause 16. The auxiliary mobility attachment according to any of the clauses 1-15, wherein the auxiliary connector comprises a position slot configured to receive at least a portion of a position rod of the wheelchair connector.
Clause 17. The auxiliary mobility attachment according to clause 16, wherein the auxiliary connector comprises a lock to retain the position rod in the position slot.
Clause 18. The auxiliary mobility attachment according to any of clauses 16-17, wherein the position slot is arranged between the driving wheel and the approach slot along the longitudinal direction of the auxiliary mobility attachment.
Clause 19. The auxiliary mobility attachment according to any of clauses 16-18, wherein the cross section of the position slot is configured to receive the cross section of the position rod.
Clause 20. The auxiliary mobility attachment according to any of the clauses 1-19, wherein the cross section of the approach slot is configured to receive the cross section of the approach rod.
Clause 21. The auxiliary mobility attachment according to any of the clauses 1-20, wherein the approach rod comprises two approach rod portions.
Clause 22. The auxiliary mobility attachment according to clause 13 or 18, wherein the longitudinal direction of the auxiliary mobility attachment is substantially parallel to the direction of the movement of the wheelchair.
Clause 23. The auxiliary mobility attachment according to any of clauses 1-22, wherein the connector body comprises a first side and a second side mutually opposed to each other, wherein the anchoring bar is arranged between the first side and the second side.
Clause 24. The auxiliary mobility attachment according to clause 23, wherein each of the first side and the second side comprises an auxiliary plate, wherein the anchoring bar is arranged between both auxiliary plates.
Clause 25. The auxiliary mobility attachment according to any of clauses 1-24, wherein the wheelchair connector is configured to be fastened to the wheelchair.
Clause 26. A mobility assembly for a wheelchair, comprising:
   an auxiliary mobility attachment according to any of clauses 1-25;
   a wheelchair connector configured to be fastened to the wheelchair.
Clause 27. A method for coupling an auxiliary mobility attachment with a wheelchair connector, comprising:
   fastening an approach rod of the wheelchair connector with an anchoring bar of the auxiliary mobility attachment;
   moving the approach rod to an approach slot in such a way that the cross section of the approach rod is received withing the cross section of the approach slot.

1. An auxiliary mobility attachment for a wheelchair, comprising:
an auxiliary frame to support a driving wheel and a handlebar;
wherein the auxiliary frame comprises an auxiliary connector releasably attached to a wheelchair connector;
wherein the auxiliary connector comprises:
a connector body, wherein the connector body comprises an approach slot to receive at least a portion of an approach rod of the wheelchair connector;
an anchoring bar fastened to the approach rod, wherein the anchoring bar is configured to be moved relative to the connector body at least between an extended position and a retracted position, such that the approach rod is secured and moved relative to the approach slot, wherein the approach slot is configured to receive the approach rod in the retracted position.

2. The auxiliary mobility attachment according to claim 1, wherein the auxiliary connector comprises an actuator to move the anchoring bar relative to the connector body between the extended position and the retracted position.

3. The auxiliary mobility attachment according to claim 2, wherein the anchoring bar comprises a rocker rotatably attached to the connector body through a first pin.

4. The auxiliary mobility attachment according to claim 3, wherein the actuator rotatably moves the rocker.

5. The auxiliary mobility attachment according to claim 3, wherein the connector body comprises a guide to slidably receive the first pin, wherein the guide comprises an extended guide end and a retracted guide end.

6. The auxiliary mobility attachment according to claim 5, wherein the guide comprises a slotted hole.

7. The auxiliary mobility attachment according to claim 6, wherein the slotted hole comprises a curved path.

8. The auxiliary mobility attachment according to claim 5, wherein the auxiliary connector comprises a spring between the connector body and the anchoring bar to urge the first pin towards the extended guide end.

9. The auxiliary mobility attachment according to claim 5, wherein the actuator moves the rocker such that the first pin is slidably moved between the extended guide end and the retracted guide end.

10. The auxiliary mobility attachment according to claim 3, wherein the rocker comprises an anchoring end to grip the approach rod and an operating end to be connected to the actuator.

11. The auxiliary mobility attachment according to claim 1, wherein the auxiliary connector comprises a position slot to receive at least a portion of a position rod of the wheelchair connector.

12. The auxiliary mobility attachment according to claim 11, wherein the auxiliary connector comprises a lock to retain the position rod in the position slot.

13. The auxiliary mobility attachment according to claim 2, wherein anchoring bar comprises a side channel to receive and guide at least a portion of the approach slot, wherein the side channel comprises an extended channel end and a retracted channel end.

14. The auxiliary mobility attachment according to claim 13, wherein the side channel comprises a curved path.

15. The auxiliary mobility attachment according to claim 13, wherein the actuator moves the rocker such that the portion of the approach slot is slidably moved between the extended channel end and the retracted channel end.

16. The auxiliary mobility attachment according to claim 13, wherein the anchoring bar comprises two side channels, wherein the two side channels are positioned at both sides with respect to the longitudinal direction of the auxiliary mobility attachment.

17. The auxiliary mobility attachment according to claim 11, wherein the position slot is arranged between the driving wheel and the approach slot along the longitudinal direction of the auxiliary mobility attachment.

18. The auxiliary mobility attachment according to claim 1, wherein the cross section of the approach slot is to receive the cross section of the approach rod.

19. A mobility assembly for a wheelchair, comprising:
an auxiliary mobility attachment for a wheelchair, comprising:
an auxiliary frame to support a driving wheel and a handlebar;
wherein the auxiliary frame comprises an auxiliary connector to be releasably attached to a wheelchair connector;
wherein the auxiliary connector comprises:
a connector body, wherein the connector body comprises an approach slot to receive at least a portion of an approach rod of the wheelchair connector;
an anchoring bar to fasten the approach rod, wherein the anchoring bar is to be moved relative to the connector body at least between an extended position and a retracted position, such that the approach rod is secured and moved relative to the approach slot, wherein the approach slot is to receive the approach rod in the retracted position;
a wheelchair connector configured to be fastened to the wheelchair.

20. A method for coupling an auxiliary mobility attachment with a wheelchair connector, comprising:
fastening an approach rod of the wheelchair connector with an anchoring bar of the auxiliary mobility attachment;
moving the approach rod to an approach slot in such a way that the cross
section of the approach rod is received within the cross section of the approach slot;
securing and moving the approach rod, by the anchoring bar, relative to the approach rod.
